(19) United States
(12) Patent Application Publication
(10) Pub. No.: US 2003/0051224 A1
(43) Pub. Date: Mar. 13, 2003

(54) Aggressive optical proximity correction method

(76) Inventors: I-Hsiung Huang, Kao-Hsiung City (TW); Kuei-Shun Chen, Hsin-Chu City (TW); Feng-Yuan Chang, Miao-Li Hsien (TW); Chien-Ming Wang, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,476

(22) Filed: Sep. 7, 2001

(51) Int. Cl. G06F 17/50

(52) U.S. Cl. 716/19

(57) ABSTRACT

A method of modifying a photo mask pattern by using computer aided design (CAD) is described. The photo mask pattern is used to manufacture a photo mask for transferal to a photoresist layer formed on a surface of a semiconductor wafer so as to form a predetermined original pattern. A first modification is first performed according to an optic proximity effect, and then a second modification is performed according to a line end shortening effect. The present invention prevents the line end shortening effect from occurring in a subsequent trim down etching process of the original pattern performed for reducing its critical dimension.

### BACKGROUND OF INVENTION

1. Field of the invention

The present invention relates to an aggressive optical proximity correction method, and more particularly, to an optical proximity correction method for preventing a line end shortening effect.

2. Description of the Prior Art

In a semiconductor process, in order to transfer an integrated circuit pattern onto a semiconductor wafer, a photo mask is manufactured first and a designed pattern is formed on the photo mask. The pattern on the photo mask is then transferred in proportion onto a photo-resist layer on the semiconductor wafer. Furthermore, the layout of an integrated circuit is successfully transferred onto the semiconductor wafer. Therefore, the photolithography process is almost the most important step in the semiconductor process.

However, as dimensions of circuit devices reduce, the difference between the circuit pattern formed on the surface of a wafer by performing a photolithography process and the original photo mask pattern increases. In particularly, corner rounding and line end shortening induced by the optical proximity effect are typically observed phenomena.

For preventing the optical proximity effect from resulting in the discrepancy between the pattern formed on the wafer and the photo mask pattern, the prior art method performs optical proximity corrections (OPC) of a photo mask pattern by using a computer aided design (CAD), so that a corrected pattern is formed on the photo mask to eliminate the optical proximity effect. Moreover, for conforming to the request of reducing a critical dimension of process, the present tendency is to perform a trim down etching process of the patterned photoresist layer after transferring the photo mask pattern onto the surface of the wafer. So, the critical dimension of process can be reduced to below the exposure limit for achieving the purpose of forming more devices in a smaller area.

Please refer to FIG. 1. FIG. 1 is a flow chart of a prior art optical proximity correction (OPC) algorithm. As shown in FIG. 1, the prior art OPC using a CAD system first inputs an original layout of the photo mask pattern to a computer memory via an input device. Then, the light illumination conditions are input for performing an optical program computation so as to simulate a wafer pattern layout formed on the semiconductor wafer. Thereafter, a program is executed to compare the wafer pattern layout simulated with the photo mask pattern layout stored in the computer memory. If the two layouts correspond, or if the comparing result is below a tolerance level, the photo mask pattern layout is outputted via an output device and then formed on a transparent photo mask. If the two layouts do not correspond, the differences in the photo mask pattern layout are modified and the modified photo mask pattern layout is stored in the memory and treated as an original layout. The calculation loop is restarted while obeying the above steps until the wafer pattern layout is the same as the modified photo mask pattern layout

Please refer to FIG. 2 and FIG. 3. FIG. 2 and FIG. 3 are cross-sectional diagrams of an original layout of a straight line pattern and two wafer pattern layouts of the original layout after development inspection and after performing a trim down etching process sequentially. FIG. 2 is a cross-sectional diagram comprising an original layout 10 and two wafer pattern layouts 14, 16 of the original layout 10 after development inspection 13 and after performing a trim down etching process 15 sequentially, while the wafer pattern layouts 14, 16 are formed without OPC. The original layout 10 is affected by optical proximity effect in the developing process 13 and affected by line end shortening effect induced by the subsequent trim down etching process 15. Therefore, there is an obvious difference between the wafer patter layout 14 and the original layout 10. FIG. 3 is a cross-sectional diagram comprising a layout 16 and two wafer pattern layouts 18, 20 of the layout 16 after development inspection 13 and after performing a trim down etching process 15 sequentially, while the wafer pattern layouts 14, 16 are formed by using OPC. The layout 16 is formed by performing OPC of the original layout 10 shown in FIG. 2. Therefore, the wafer pattern layout 20 corresponds more closely to the original layout 10.

However, the prior art method of OPC of photo mask pattern is used primarily to eliminate optical proximity effect, and line end shortening effect induced by the trim down etching process is not considered. So, there is quite a difference between the original layout and the wafer pattern layout formed by a photolithography process. Furthermore, the problems of defocus and reduced exposure latitude (EL) occur and result in serious clarity loss of the photo mask pattern. As well, the process window may be not enough for preventing line end shortening effect. This situation is most obvious when the least critical dimension is reduced to under 0.13 microns.

### SUMMARY OF INVENTION

It is therefore a primary objective of the present invention to prevent line end shortening effect induced by a trim down etching process for solving problems such as defocus and reduced exposure latitude as well as improving process widow.

In a preferred embodiment, the present invention provides a method of modifying a photo mask pattern by using computer aided design (CAD). The photo mask pattern is used to manufacture a photo mask for being transferred on a photoresist layer formed on a surface of a semiconductor wafer so as to form a predetermined original pattern. The present invention method first performs a first modification according to optic proximity effect, and then performs a second modification according to line end shortening effect. The present invention can prevent the line end shortening effect occurring in the subsequent trim down etching process performed of the original pattern for reducing its critical dimension.

It is an advantage of the present invention that the method uses two modification programs to modify the photo mask pattern for improving optical proximity effect in a photolithography process and line end shortening effect resulting from the subsequent trim down etching process. Furthermore, the induced problems such as clarity loss of photo mask patterns, defocus and reduced exposure latitude will be solved.

These and other objectives of the present invention will no doubt become obvious to those of ordinary skill in the art after having read the following detailed description of the preferred embodiment which is illustrated in the various figures and drawings.

### BRIEF DESCRIPTION OF DRAWINGS

FIG. 1 is a flow chart of a prior art optical proximity correction algorithm.

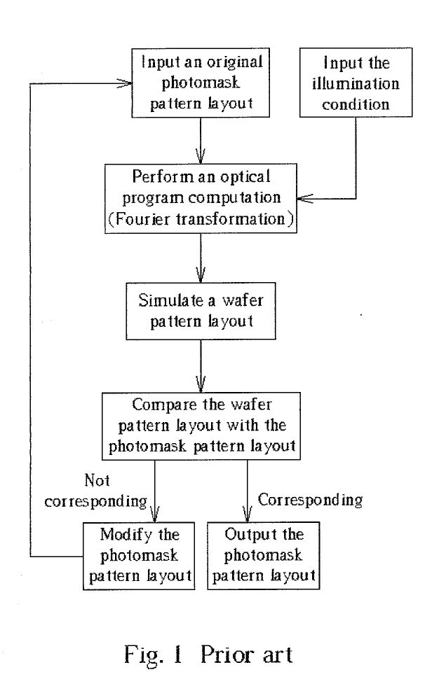

FIG. 2 is a cross-sectional diagram comprising an original layout and two wafer pattern layouts of the original layout after development inspection and after performing a trim down etching process sequentially, while the wafer pattern layouts are formed without OPC.

FIG. 3 is a cross-sectional diagram comprising a layout and two wafer pattern layouts of the layout after development inspection and after performing a trim down etching process sequentially, while the wafer pattern layouts are formed by using the prior art OPC method.

FIG. 4 is a flow chart of the present invention aggressive optical proximity correction algorithm.

FIG. 5 is a cross-sectional diagram comprising a layout and two wafer pattern layouts of the layout after development inspection and after performing a trim down etching process sequentially, while the wafer pattern layouts are formed by using the present invention aggressive OPC method.

### DETAILED DESCRIPTION

The present invention provides an aggressive OPC method of modifying a photo mask pattern by using computer aided design (CAD). The photo mask pattern is used to manufacture a photo mask, which is used in a photolithography process for forming a predetermined original pattern on a photoresist layer positioned on a predetermined region of a semiconductor wafer. The present invention aggressive OPC method first performs a first modification on a photo mask pattern according to a predetermined optic proximity effect for reducing the optic proximity effect that may occur during a process of transferring the photo mask pattern from a photo mask onto a surface of a semiconductor wafer. Then, a modification program comprising a multi-level equation is used to perform a second modification on the photo mask pattern according to line end shortening effect induced by a trim down etching process. After transferring the photo mask pattern onto a photoresist layer formed on a surface of a semiconductor wafer, another trim down etching process of the patterned photoresist layer is performed so as to reduce the least critical dimension of the original pattern to under 0.13 microns.

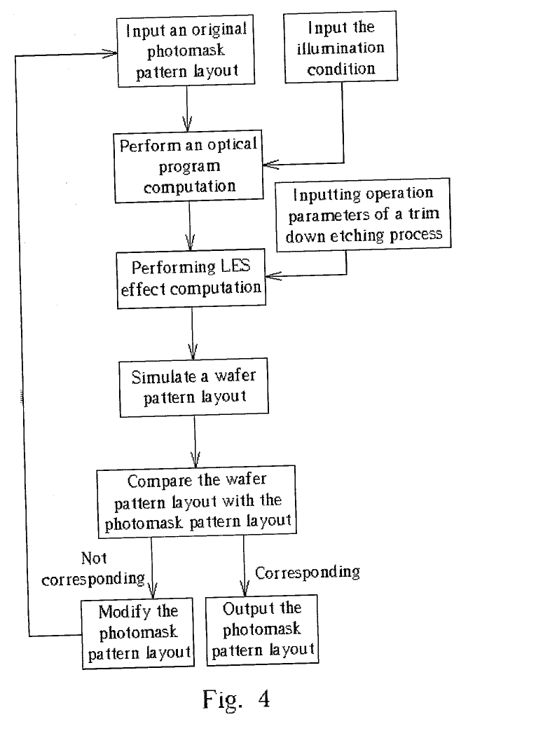

Please refer to FIG. 4. FIG. 4 is a flow chart of the present invention aggressive optical proximity correction (OPC) algorithm. As shown in FIG. 4, the present invention first inputs an original layout of the photo mask pattern to a computer memory via an input device. Then the light illumination conditions are inputted for performing an optical program computation. The optical program computation is used to prevent resolution loss induced by overexposure or underexpose during an exposure process of the photo mask pattern. Furthermore, the original pattern transferred in the photoresist layer is prevented from optical proximity effect such as corner rounding effect. Thereafter, the operation parameters of a trim down etching process are inputted for performing a program computation of line end shortening effect. The operation parameters of the trim down etching process can be obtained by reverse calculating according to the outcome of line end shortening effect occurring in a prior semiconductor process.

Finally, a wafer pattern layout to be formed on a surface of a wafer is simulated by combining the above-mentioned two results of the program computations. Then, the simulated wafer pattern layout is compared with the photo mask pattern layout stored in computer memory. If the two layouts correspond, or if the comparing result is below a tolerance level, the photo mask pattern layout is outputted via an output device. If the two layouts do not correspond, the differences in the photo mask pattern layout are modified and the modified photo mask pattern layout is stored in the memory and treated as an original layout. The calculation loop is restarted while obeying the above steps until the wafer pattern layout is the same as the modified photo mask pattern layout, then outputting the modified photomask pattern layout.

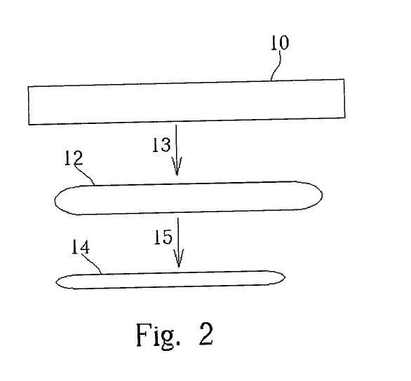

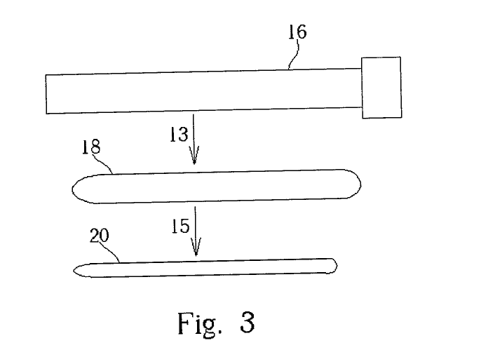

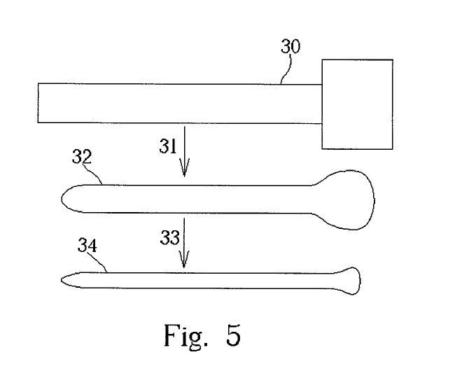

Please refer to FIG. 5. FIG. 5 is a cross-sectional diagram comprising a layout 30 and two wafer pattern layouts 32, 34 of the layout 30 after development inspection 31 and after performing a trim down etching process 33, sequentially. The layout 30 is formed by performing an aggressive OPC of the present invention of the original layout 10 shown in FIG. 2. In contrast to the wafer pattern layout 20, which is formed by using a prior art OPC, shown in FIG. 3, the wafer pattern layout 34 formed by using aggressive OPC of the present invention is more similar to the original layout 10.

The present invention uses two modification programs to modify the photo mask pattern for improving optical proximity effect in a photolithography process and line end shortening effect resulting from the subsequent trim down etching process. Furthermore, the induced problems such as clarity loss of photo mask patterns, defocus and reduced exposure latitude will be solved.

In contrast to the prior art method, the present invention not only considers optical proximity effect but also considers line end shortening effect. Therefore, line end shortening effect, which the prior art OPC fails to solve for, can be prevented from occurring in a trim down etching process of a patterned photoresist layer for reducing the critical dimension of a process.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An aggressive optical proximity correction method used for modifying photo mask patterns, the method comprising:
examining the photo mask patterns according to a condition of an optic proximity effect, and performing a first modification on a portion of the photo mask patterns conformed to the condition so as to eliminate the optic proximity effect that will happen on the portion of the photo mask patterns conformed to the condition; and
examining the first modified photo mask patterns according to a condition of a line end shortening effect, and performing a second modification on the portion of the first modified photo mask patterns conformed to the condition so as to eliminate the line end shortening effect that will happen on the portion of the first modified photo mask patterns conformed to the condition.

2. The aggressive optical proximity correction method of claim 1 wherein the photo mask patterns modified by the aggressive optical proximity correction method are transferred on a photoresist layer formed on a surface of a semiconductor wafer so as to form predetermined original patterns in the photoresist layer.

3. The aggressive optical proximity correction method of claim 2 wherein a trim down etching process of the original patterns formed in the photoresist layer is performed for reducing a critical dimension of the original patterns.

4. The aggressive optical proximity correction method of claim 3 wherein the line end shortening effect is induced by the trim down etching process.

5. The aggressive optical proximity correction method of claim 3 wherein the critical dimension of the original patterns is smaller than 0.13 microns.

6. The aggressive optical proximity correction method of claim 1 wherein the optic proximity effect results from resolution loss induced by overexposure or underexposure.

7. The aggressive optical proximity correction method of claim 1 wherein the optic proximity effect is a corner rounding effect.

8. A method of modifying an original photo mask pattern by using a computer, the computer comprising a memory for storing the original photo mask pattern, a first examination program, a second examination program, a first modification program, and a second modification program, and a processor for executing the programs stored in the memory, the method comprising:
using the processor to execute the first examination program for examining the original photo mask pattern stored in the memory according to a condition of an optic proximity effect, and performing a first modification by using the first modification program on a portion of the photo mask pattern conformed to the condition so as to eliminate the optic proximity effect that will happen on the portion of the photo mask pattern conformed to the condition; and
using the processor to execute the second examination program for examining the first modified photo mask pattern according to a condition of a line end shortening effect, performing a second modification by using the second modification program on the portion of the first modified photo mask pattern conformed to the condition so as to eliminate the line end shortening effect that will happen on the portion of the photo mask pattern conformed to the condition, and forming a second modified photo mask pattern;
wherein the second modified photo mask pattern is formed on a surface of a photo mask for being transferred to a photoresist layer formed on a surface of a semiconductor wafer in a photolithography process so as to form a corresponding original pattern in the photoresist layer.

9. The method of claim 8 wherein the second modification program comprises amulti-level equation.

10. The method of claim 8 wherein the optic proximity effect results from resolution loss induced by overexposure or underexposure.

11. The method of claim 8 wherein the optic proximity effect is a corner rounding effect.

12. The method of claim 8 wherein a trim down etching process of the original patterns formed in the photoresist layer is performed on for reducing a critical dimension of the original patterns.

13. The method of claim 12 wherein the line end shortening effect is induced by the trim down etching process.

14. The method of claim 12 wherein the critical dimension of the original patterns is smaller than 0.13 microns.
